(19) United States
(12) Patent Application Publication
(10) Pub. No.: US 2003/0236709 A1
(43) Pub. Date: Dec. 25, 2003

(54) Method and apparatus for generation and sending of print media from a wireless communication device

(76) Inventors: Kendro Hendra, Jakarta (ID); Jawahar Kanjilal, Singapore (SG)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/176,677

(22) Filed: Jun. 24, 2002

(51) Int. Cl. G06F 17/60

(52) U.S. Cl. 705/26; 705/401

(57) ABSTRACT

A method and apparatus for generating media from a wireless communication device that includes acquiring a picture for a media. The picture may be taken by a camera, selected from a menu of pictures, or inputted into the wireless communication device. A text message is generated for the media. A mailing address is inputted or selected for the media. Media information is created from the picture, text message, and mailing address and sent to a server. The server stores the media information. The media information is retrieved from the server by a second server. The media is created and the created media mailed to the mailing address. Preferably, the second server is located in the country of the mailing address or in close proximity to the mailing address. The media may be a poster, stickers, a postcard, a greeting card, a banner, a sign, a mug, or a plate.

### BACKGROUND

1. Field of the Invention

This invention relates to networks, and more specifically to generation and sending of print media from a wireless communication device.

2. Discussion of the Related Art

People travel all over the world daily visiting various locations. One way that many people send friends and family notice of their travels is by sending some form of print media, such as a card or a postcard, or other media with an image and/or print such a coffee mug. Generally, a person purchases a media with an image at the location that the person is visiting. The person may then write a text message on the media, put postage on the postcard or envelope/package containing the media, and a mailing address, and deposit the media in the postal system at the location that the visitor is at. Depending on how far away the visitor is from the mailing address of the media, the media may take several days to weeks to arrive at the mailing address. This is problematic in that many times the visitor is back home before the media actually arrives at the mailing address.

Moreover, generally media, such as cards, postcards, mugs, etc., are selected with preprinted images on them. An individual has no way of creating or selecting their own desired image to be placed on a media. Thus, the media with the preprinted pictures may not be as personable, or adequately reflect the scenes, images, etc. at the location that the visitor may desire for their friends and family to see on the media.

Therefore, a need exists for creation of media where any image that one may want to capture and would like to share in a media format may be created and delivered to a recipient on a printed media or other media created and personalized in this manner.

### SUMMARY OF THE INVENTION

The present invention relates to a method for generating media from a wireless communication device that includes: acquiring a picture for a media; generating a text message for the media; inputting a mailing address for the media; creating media information from the picture, text message, and mailing address; sending the media information to a server, where the server stores the media information; retrieving the media information from the server by a second server; creating the media; and mailing the created media to the mailing address. The media may be created by a printer or another type of apparatus usable for creating the media. The media may be a poster, stickers, a postcard, a greeting card, a banner, a sign, a mug, or a plate.

The second server and printer/apparatus may be located in the country of the mailing address. The postcard information may be sent to the server via the Internet and accessed by the second server via the Internet.

The present invention also relates to a system for generating media from a wireless communication device that includes a wireless communication device, a server, and a second server all operatively connected to a network. The wireless communication device generates postcard information that includes a picture, a text message, and a mailing address. The server receives the postcard information from the wireless communication device and stores the postcard information. The second server retrieves the postcard information from the server. The media from the media information is created on a device attached to the second server that allows mailing of the media to the mailing address.

The network may be the Internet. The wireless communication device may be a mobile phone.

The present invention further relates to a method for generating media from a wireless communication device that includes: taking a picture for a media; generating a text message for the media; inputting a mailing address for the media; creating media information from the picture, text message, and mailing address; sending the media information to a network printer, the network printer printing the media; and mailing the printed media to the mailing address. The media may be a poster, stickers, a postcard, a greeting card, a banner, or a sign.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a schematic block diagram illustrating a mobile telephone handset that can communicate through a Public land Mobile Network (PLMN) to a Wireless Application Protocol (WAP) server according to an example embodiment of the present invention;

FIG. 2 is a schematic block diagram of example circuitry of the mobile handset shown in FIG. 1;

FIG. 3 is a diagram of a system for generation and sending of postcards from a wireless communication device according to an example embodiment of the present invention;

FIG. 4 is a diagram of a system for generation and sending of postcards from a wireless communication device according to another example embodiment of the present invention;

FIG. 5 is a flowchart of an example process for generation and sending of postcards from a mobile wireless communication device according to an example embodiment of the present invention;

FIG. 6 is a flowchart of a process for generation and sending of postcards from a kiosk according to an example embodiment of the present invention;

FIG. 7 is a flowchart of a process for generation and sending of postcards from a web server according to an example embodiment of the present invention;

FIG. 8 is a flowchart of a process for accessing and printing postcards according to an example embodiment of the present invention; and

FIG. 9 is a flowchart of a process for payment of a postcard according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention relates to method and apparatus for generation and sending of print media from a wireless communication device where a wireless communication device, such as a mobile phone, may generate and send information to a server including pictures, images, text, etc. that may be forwarded or retrieved by a second server to be created on the appropriate medium. According to the present invention information may be generated and sent by a wireless communication device for the creation of postcards, stickers, posters, banners, greeting cards, signs, mugs, plates, etc. The second server may be operatively attached to a printer for printing postcards, stickers, posters, banners, greeting cards, or signs, or operatively attached to another type apparatus for creation of personalized mugs, plates, etc.

The wireless communication device preferable is equipped with a camera allowing a user to take personalized images for inclusion on one or more of the these medium. A user may enter text and a mailing address to be included in the information sent allowing the medium (postcards, stickers, posters, banners, greeting cards, mugs, plates, etc.) to be printed, manufactured, or modified with the user generated images and text, and then mailed to the mailing address. For example, a tourist in Australia may create the information. The information may then be sent or routed to a server where it may be retrieved from the server by the appropriate print server or other server servicing a manufacturing facility for inclusion on the medium. The print server or other server may be located close to the mailing address saving costs and time for delivery of the printed media to its destination.

To illustrate the present invention, example embodiments where the wireless communication device is a mobile phone with a digital camera, and where the print media is a postcard will be used. However, the present invention is not limited by these embodiments and includes all other types of wireless communication devices (e.g., servers, workstations, desktop computers, Personal Digital Assistants (PDAs), portable computers, etc.) and media with print/images (e.g., greeting cards, stickers posters, signs, banners, mugs, plates, etc.) that are within the spirit and scope of the present invention.

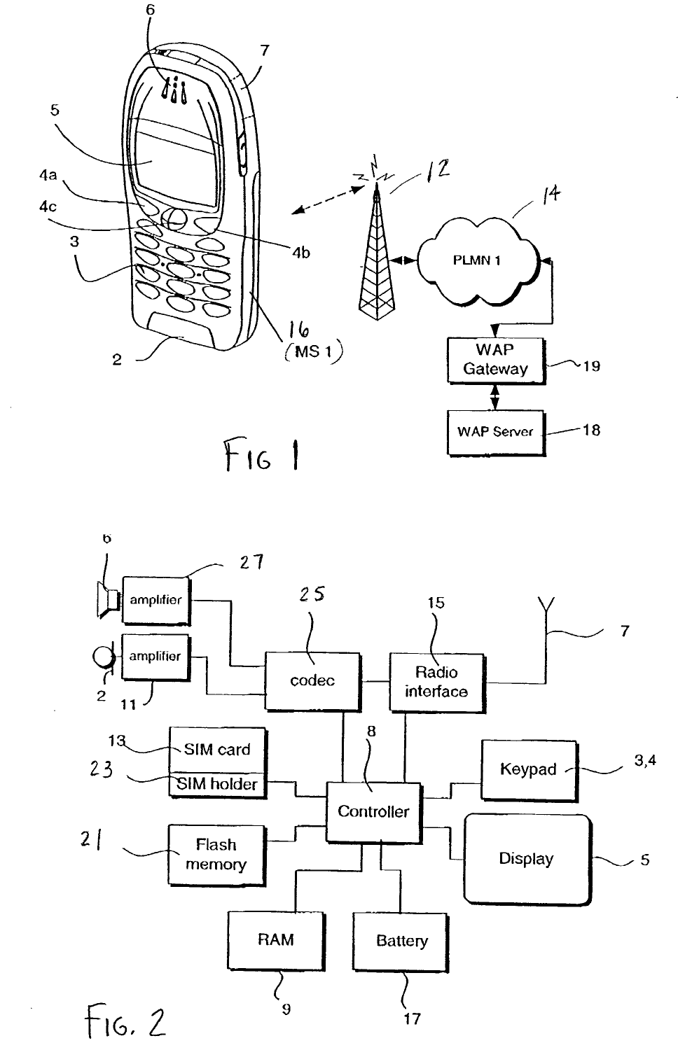

FIG. 1 is a schematic block diagram illustrating a mobile telephone handset that can communicate through a Public land Mobile Network (PLMN) to a Wireless Application Protocol (WAP) server according to an example embodiment of the present invention. A mobile station (MS) in the form of a battery driven telephone cellular handset 16 (MS1), is shown schematically in radio communication with PLMN 1. The cellular handset 16 may communicate to a WAP server 18 through an antenna 12, a PLMN 14, and a WAP gateway 19. The mobile handset MS1 may include a microphone 2, keypad 3, further keys comprising soft keys 4a, 4b and a navigation key 4c, a liquid crystal display 5, earpiece 6 and internal antenna 7. The handset 16 (MS1) may be WAP-enabled. An example of a WAP-enabled mobile handset is the Nokia 6210™. Although not shown in the figure, the cellular handset 16 may include a digital camera integral with the handset.

FIG. 2 is a schematic block diagram of example circuitry of the mobile handset shown in FIG. 1. Signal processing may be carried out under the control of a digital micro-controller 8 that may have associated RAM 9 and flash memory 21. Electrical analog audio signals may be produced by microphone 2 and amplified by a pre-amplifier 11. Similarly, analogue audio signals are fed to the earpiece 6 through an amplifier 12. The micro-controller 8 may receive instruction signals from the keypad 3, soft keys 4a, 4b and navigation key 4c and controls operation of the LCD display 5. The soft-keys 4a, 4b may comprise user-programmable keys, while the navigation key 4c may comprise, for example, a roller device to perform a scrolling function for the display.

Information concerning the identity of the user (of the mobile handset 16) may be held on a smart card 13 in the form of a GSM SIM card which contains the usual GSM international mobile subscriber identity and encryption Kᵢ that is used for encoding the radio transmission in a manner well known. The SIM card 13 may be removably received in a SIM card holder 23. Radio signals are transmitted and received by means of the antenna 7 connected through a radio frequency (RF) stage 15 to a codec 25 configured to process signals under the control of the micro-controller 8. Thus, in use, for speech, the codec 25 may receive analog signals from the microphone amplifier 11, digitize them into a form suitable for transmission, and feed them to the RF stage 15 for transmission through antenna element 7 to the PLMN 1, 14, shown in FIG. 1. Similarly, signals received from the PLMN 1, 14 may be fed through the antenna element to be demodulated by the RF stage 15 and fed to codec 25 so as to produce analog signals fed to amplifier 27 and earpiece 6.

The handset MS1 may be WAP enabled and capable of receiving data in a predetermined channel, e.g. for GSM, at 9.6 Kbit/sec. Also, the handset may be configured to receive high-speed circuit switched data (HSCSD) according to the GSM recommendations, at a data rate from 14.4-43.2 kbit/sec. However, the present invention is not limited to any particular data rate and higher rates may be used and still be within the limitations and scope of the present invention. The WAP content and its applications are specified in a well known set of content formats based on familiar www content formats. WAP is disclosed in the WAP Forum Specifications made by different working groups within the WAP Forum.

The WAP environment (WAE) provides a browser e.g. a micro-browser operable on the handset as a client, for connection to WAP servers. The browser may be configured to operate with Wireless Markup Language (WML), which comprises a lightweight markup language similar to HyperText Markup Language (HTML) but optimized for use in hand-held mobile terminals.

Data may be downloaded to the browser from a WAP server such as server 18 shown in FIG. 1. The server 18 provides WML decks of cards, corresponding to conventional pages of HTML, such that a deck can be downloaded to the handset MS1 and the individual cards manipulated for display by means of the keys 3, 4. The server 18 may be accessed through a gateway 19 which acts as a proxy server. The handset 16 may access the gateway 19 by dialing a predetermined telephone number.

The WML data downloaded from the server 18 may be held in the RAM 9 or the flash memory 21. The microcontroller 8 provides the microbrowser functionality and causes individual cards of the downloaded WML deck to be presented to the user via the browser on the screen of the display 5.

In order to simplify operation of the browser on the handset MS1, settings for the browser may be ‘pushed’ to the handset MS1 from the network when the handset is initially connected to the network PLMN 1. Thus, the network may provide the handset with telephone numbers and IP addresses for servers that the user can access to receive WAP data.

The mobile device 16 may run a browser, commonly referred to as a microbrowser, to display data from a content server. The browser acts as a client that communicates with the content server via a WAP proxy server or gateway. The proxy server translates between the WAP protocols used by the browser and the Internet protocols such as HTTP (HyperText Transfer Protocol) used to communicate with the content server. Navigation between different decks and their respective cards may be controlled by the user with keys on the mobile device 16. Typically, the mobile device has a smaller number of keys than a conventional personal computer and does not have a mouse, so that navigating with the browser of the mobile device can be difficult for the user. In particular, each key on a mobile handset is typically associated with a group of three or more letters of the alphabet, so that a particular letter is chosen by pressing keys a number of times in quick succession. This is by no means a straightforward method of entering long strings of letters, such as those making up a WAP address.

When a WAP enabled mobile telecommunications device is first connected for use with a mobile network, initialization data to enable the device to connect to the server may be supplied to the mobile device through the mobile network, in the form of a data message. For example, the initial data may be transmitted in a so-called WAP push, which is a feature of the WAP protocol used for sending unsolicited information from the server to the client.

The push with the initialization information may be sent as a short message service (SMS) message or as a GSM Unstructured Supplementary Service Data (USSD) message. In this way, the mobile device is provided with a number of pre-set server addresses, which can be selected by the user to provide access to information services, commercial organizations and the Internet in general. By providing the settings initially as a push to the handset, the number of keystrokes that need to be performed on the mobile device to access a server are reduced significantly, simplifying operation for the user.

A user browsing the Internet via a conventional web browser may come across sites which claim to be WAP-enabled. The user may wish to view those sites via his WAP telephone, but can only do so by entering the URL of the site, commonly referred to as a bookmark, into the WAP browser.

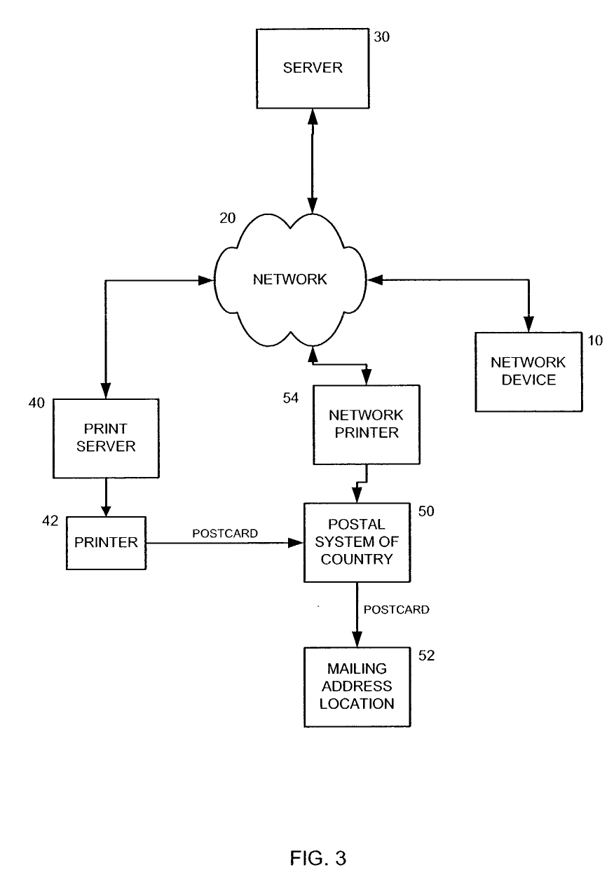

FIG. 3 shows a diagram of a system for generation and sending of postcards from a wireless communication device according to an example embodiment of the present invention. A user at wireless communication device 10 may take a picture, create a picture or image, select a picture or image, or load a picture or image at wireless communication device 10 to be used on a postcard. The user at wireless communication device 10 may also enter a text message to go on the post card along with the image, and a mailing address where the postcard is to be sent. Wireless communication device 10 may take the image, text message and mailing address, and generate postcard information that may then be sent to a server 30 through a network 20. Network 20 may be any network wired or wireless, as well as the Internet. Server 30 receives the postcard information and stores the postcard information.

A print server 40, preferably located in the country of the mailing address, retrieves the postcard information from the server 30 through the network 20. After retrieving the postcard information from server 30, print server 40 may then control the printing of the postcard on printer 42. The postcard may then be sent to the postal system of the country 50 where it is delivered to the mailing address location 52.

In another embodiment of the present invention, the system may include a network printer 54 that has its own network address. The wireless communication device 10 may then send the postcard information directly to the printer 54 for printing through the network 20. The postcard may then be mailed using the postal system of the country where the printer is located. For example, if the network is the Internet, then the network printer may have an Internet Protocol (IP) address of its own allowing postcards to be directly received at the printer from the network.

The transmission of the postcard may be by using a telecommunication network that is connected to the wireless communication device, WLAN (Wireless Local Area Network) or Bluetooth. The wireless communication device may receive the IP address by establishing a connection to a server, which may connect to a preferred printer, and request for a specific IP address at the printer. This may be done by sending a “PULL” message to the server, where the server responds to the request by sending a message back to the wireless communication device comprising information about the IP address to the printer. The wireless communication device may also receive the IP address directly from the server, if the server is set up to send a “PUSH” message as a result of a programmed request from the wireless communication device. The user interface may comprise an application allowing the user to search for printers. The application may then arrange a connection to a server, which may be connected locally via Bluetooth or WLAN, or connected through the Internet via a telecommunication network. The user may use a WAP browser to establish a connection to the server. In this way the user may be independent of a service provider to create their own postcard, and do the posting themselves or ask a friend to take care of the posting of the postcard.

Therefore, according to the present invention, a postcard created by a user on a wireless communication device at one location, may be printed and mailed at another location, and delivered to the mailing address. This is highly efficient in that the postcard is delivered much faster, and a user is able to personalize or customize the image or picture used on the postcard. The wireless communication device 10 may be a device such as a mobile phone, or may be a kiosk or a web server with a web page allowing a user to create postcard information. Although preferably, the postcard is printed at a printer located in the country of the mailing address and mailed using the postal system of that country, postcards may be printed in countries other than the location of the mailing address of the postcard and then sent via one or more postal systems to that mailing address and still be within the limitations and scope of the present invention.

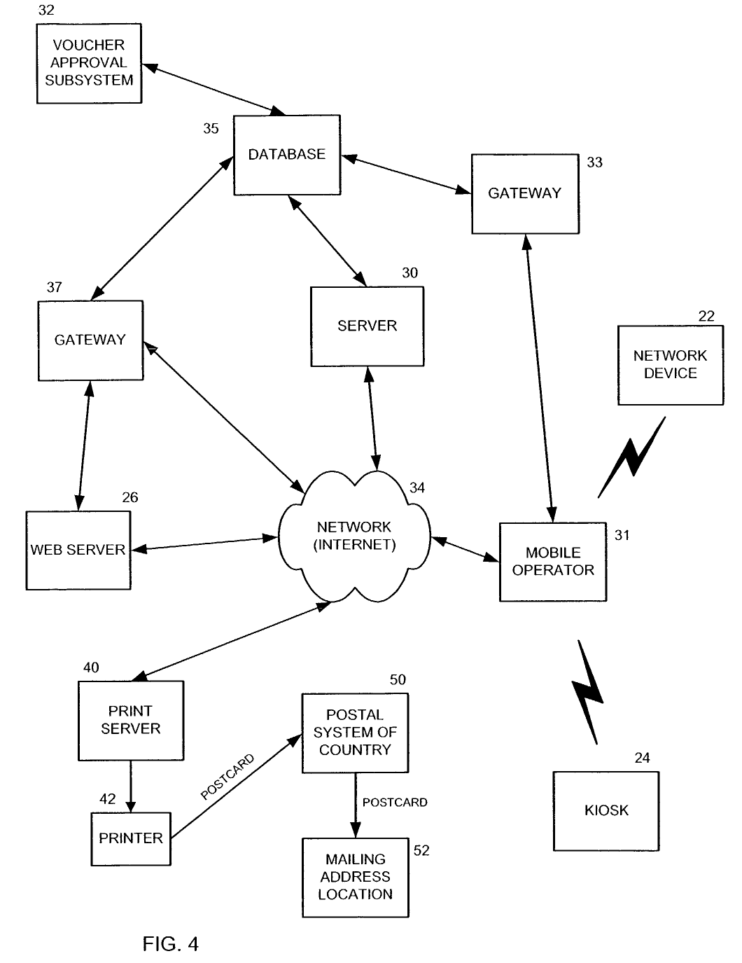

FIG. 4 shows a diagram of a system for generation and sending of postcards from a wireless communication device according to another example embodiment of the present invention. In this example system embodiment, three example wireless communication devices are shown that may be used by a user to create postcard information for printing and mailing of a postcard. These three wireless communication devices include a mobile network device 22, a kiosk 24, and a web server 26. These wireless communication devices may create postcard information that may be sent through network 34 and stored at server 30. In this example system embodiment, network 34 may be the Internet.

Mobile network device 22 may be any mobile device, e.g., a mobile phone, portable computer, personal digital assistant (PDA), etc. A user at mobile network device 22 may take a picture or image using mobile network device 22, or may select a picture or image stored at mobile network device 22. Further, a user at mobile network device 22 may load or send to mobile network device 22 an image or picture desired to be used on a postcard. Mobile device 22 may be equipped with an internal camera for taking a picture, or an external camera connected to mobile network device 22. For example, mobile network device 22 may be a Nokia 7650 mobile phone that has a digital camera included.

A user at mobile network device 22 may enter a text message for the postcard, along with a mailing address that the postcard is to be sent. Mobile network device 22 may take the image, text message, and mailing address and generate postcard information that may then be sent to a mobile operator 31. Further, mobile network device 22 may calculate a cost for the postcard based on the destination address and prompt the user on accepting this cost. The user may then accept the cost, and choose a billing method to pay for the cost. The billing method may include operator billing (e.g., billed to his home, credit card, bank account, etc.), or may include voucher billing whereby the user submits an electronic voucher which will be used to cover the cost of the postcard. This payment information may also be sent from mobile network device 22 to mobile operator 31.

Mobile operator 31 may forward the postcard information to server 30 through the Internet 34. Mobile operator 31 may approve or disapprove of the operator billing method (if this is the method chosen by the user) and notify the user via mobile network device 22 accordingly. If operator billing is selected by the user and payment approved by the mobile operator 31, or if the user has used a voucher as a payment method, mobile operator 31 may send the payment information to a database 35 through a gateway 33. Gateway 33 merely interfaces mobile operator 31 to database 35 and may or may not exist depending on the network architecture.

Database 18 stores the billing information and may forward the voucher information to a voucher approval subsystem 32 that approves and verifies the voucher information. Upon approval of the voucher, database 35 may forward the voucher approval to mobile network device 22 through gateway 33 and mobile operator 31.

Similarly, the system may include a kiosk 24 that allows a user at the kiosk to either take a picture or select from a menu of pictures at the kiosk to be used for a postcard. The user takes or selects a picture or image, enters a text message for the postcard, and a destination or mailing address for the postcard. The kiosk takes this information and may generate postcard information that is then sent to mobile operator 31 to be transferred through the Internet 34 to server 30. After entering the mailing address at the kiosk, the kiosk may prompt the user with a cost for the postcard. The user may then enter the required cost directly into the kiosk, therefore, paying for the cost of the postcard. The kiosk may be equipped with a camera allowing a user to take a picture at the kiosk for use on the postcard.

A web server 26 may also be part of the system allowing a user to enter postcard information at a web page hosted by the web server. A user may access this web page directly by being at the web server, or may access the web page remotely via use of the Internet. The user may load a picture or send a picture to the web server for use on the postcard or may select a picture or image from a menu of pictures and/or images at the web server. Further, the user may manipulate, modify, or in some other way change a picture or image at the web server for use on the postcard. A user may also elect to create an image from scratch at the web server for use on the postcard. The user may then enter a text message and mailing address for the postcard, whereby the web server may create postcard information and send this to server 30 through the Internet 34.

A cost for the postcard may be generated by web server 26 and presented to the user for approval. Upon approval, the user may be billed for the postcard via the user's Internet service provider (ISP) or some other billing method. The billing information may be sent from web server 26 through gateway 37 to database 35 for storage.

Once the postcard information is stored at server 30, it may reside there until retrieved by a print server 40 located within the country of the mailing address location 52, or some other location. Print server 40 may retrieve the postcard information from server 30 through the Internet 34. The postcard information may be downloaded from server 30 using the Internet 34 to print server 40 whereby print server 40 may send the postcard to a printer 42 for printing. Once the postcard is printed, it may be mailed using the postal system of the country where the print server is located 50. Preferably, the postal system 50 is located in the same country as the mailing address location 52. The postal system delivers the postcard to the mailing address 52. It is advantageous for the print server to be in the country of the mailing address since a postcard may be created by a user anywhere in the world, but printed and mailed in the same country as the mailing address, therefore, saving time and money.

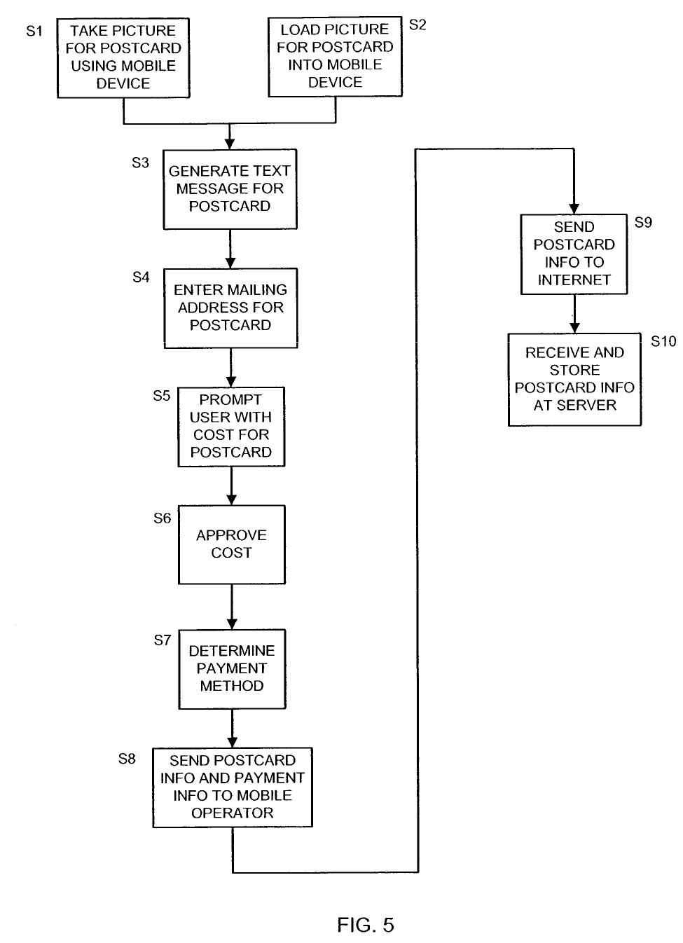

FIG. 5 shows a flowchart of an example process for generation and sending of postcards from a mobile network device according to an example embodiment of the present invention. A user at the mobile device may take a picture for the postcard using the mobile device S1, or may load a picture for the postcard into the mobile device S2. The mobile device may also have a menu of pictures from which the user may select. The user generates a text message for the postcard S3. The user enters a mailing address for the postcard S4. The mobile device may then prompt the user with a cost for the postcard S5. The user may then approve the cost S6 and decide on a payment method for payment of the postcard S7. The mobile device may then send the postcard information that includes the picture or image, text message, and mailing address, along with payment information to a mobile operator S8. The mobile operator may then forward the postcard information to the Internet S9 where the postcard information may be routed to a server. The server may receive and store the postcard information S10.

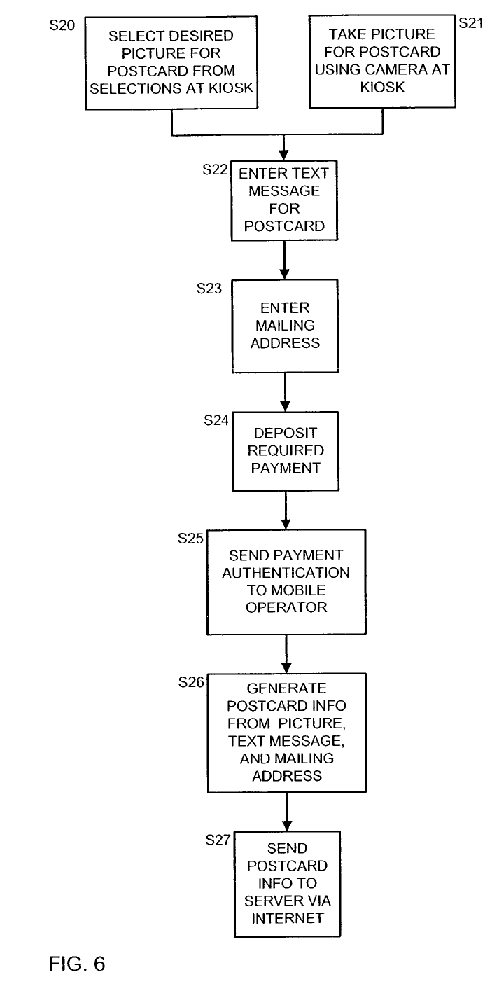

FIG. 6 shows a flowchart of a process for generation and sending of postcards from a kiosk according to an example embodiment of the present invention. A user at a kiosk may select a desired picture from a menu of pictures or images at the kiosk for the postcard S20, or may take a picture for the postcard using a camera at the kiosk S21. The user may then enter a text message and a mailing address for the postcard S22, S23. The kiosk may then prompt the user with a cost for the postcard whereby the user may deposit the required payment into the kiosk S24. The kiosk may send payment authentication to a mobile operator S25. The kiosk may generate postcard information from the picture, text message and mailing address S26, and send this postcard information to a server via a network or the Internet, where the server may store the postcard information S27.

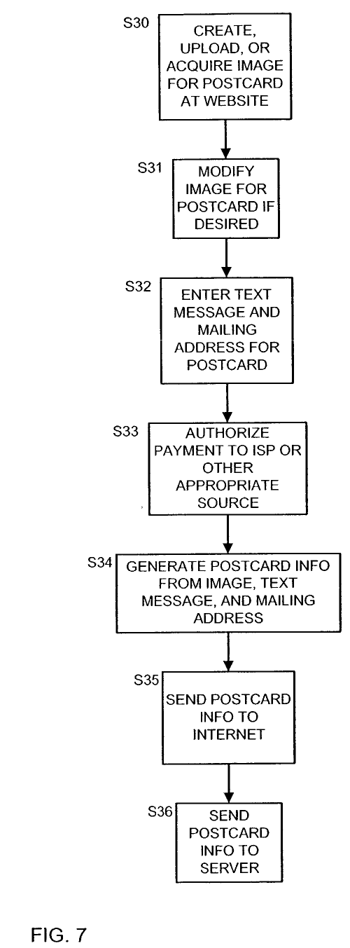

FIG. 7 shows a flowchart of a process for generation and sending of postcards from a web server according to an example embodiment of the present invention. An image or picture is created, uploaded or acquired for the postcard at the web site at the web server S30. A user may modify the image for the postcard if desired S31. The user enters a text message in mailing address for the postcard at the website S32. The web server may generate a cost for the postcard based on the mailing address, and the user may authorize payment to an Internet service provider or other appropriate source (e.g., credit card) S33. Postcard information may be generated at the web server from the image, text message and mailing address S34. The postcard information may be sent from the mail server to a network or the Internet S35 where it may be forwarded to a server S36, and stored there. Verification of billing may also be sent from the web server to the database through a gateway.

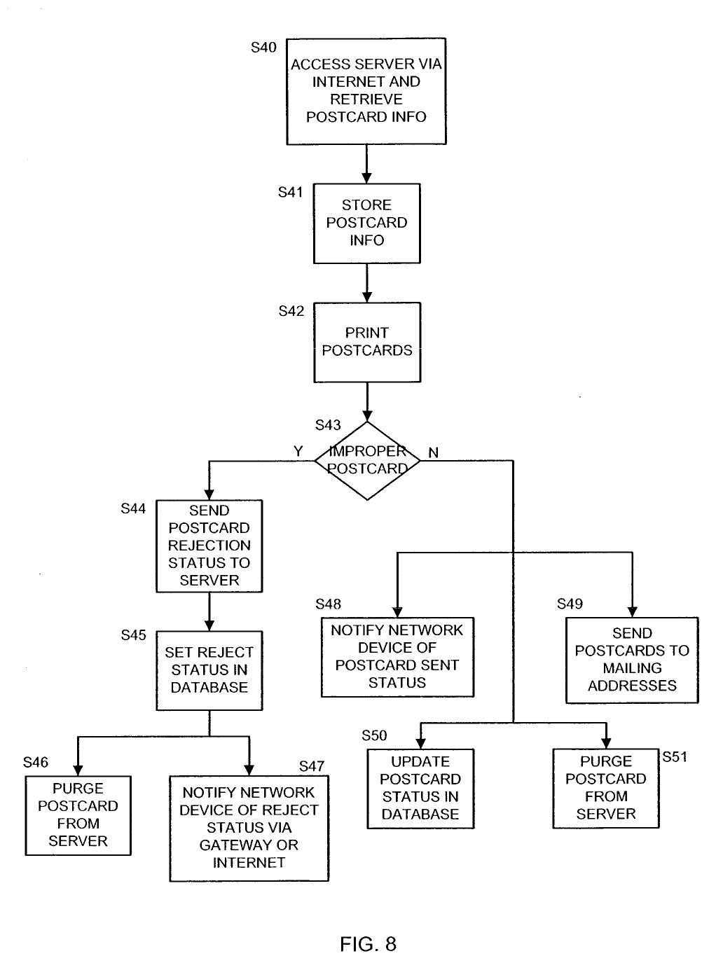

FIG. 8 shows a flowchart of a process for accessing and printing postcards according to an example embodiment of the present invention. A print server may access a server containing the postcard information via a network or the Internet and retrieve the postcard information S40. The print server may store the postcard information S41 and then send the postcard to a printer for printing S42. In some countries, postcards containing improper content may not be mailed, therefore, a check may be made to determine if the postcard has improper material S43. If the postcard does have improper material, a rejection status may be sent to the server S44 and a reject status set in a database S45. The postcard information may then be purged from the server S46 and the wireless communication device notified of the reject status via a gateway or the Internet S47. If the postcard is proper, the wireless communication device may be notified that the postcard has been mailed S48, the postcard mailed to the mailing address S49, the postcard status updated in the database S50, and the postcard information purged from the server S51.

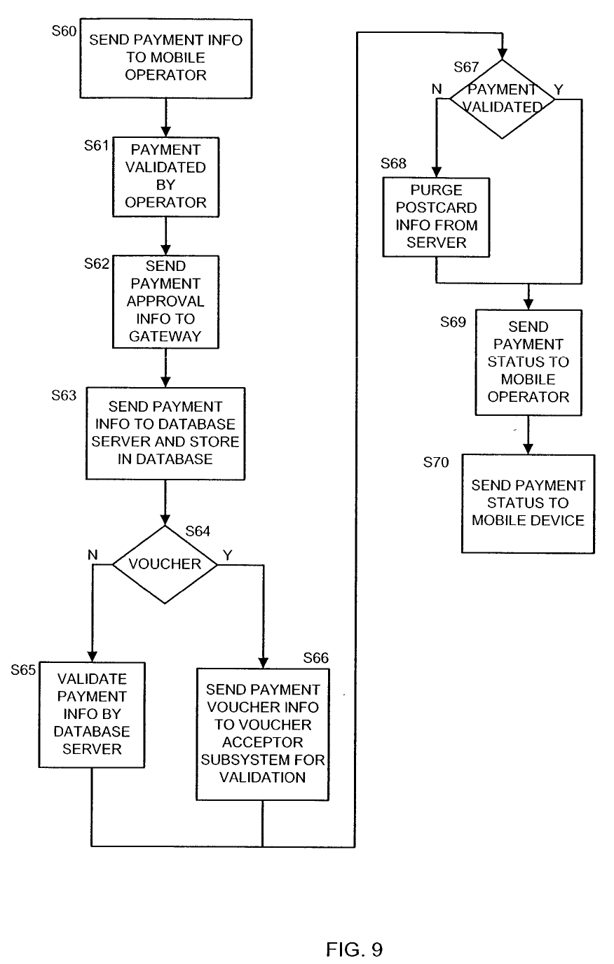

FIG. 9 shows a flowchart of a process for payment of a postcard according to an example embodiment of the present invention. Generally, for a kiosk and web server embodiments, payment for the postcard may already have been made and, therefore, only payment verification information sent. For a mobile device, payment may need to be approved, or vouchers verified, before payment is actually verified. Payment information may be sent to a mobile operator or a gateway S60. If necessary, the payment may be validated by the mobile operator S61. Payment approval may then be sent to a gateway S62. The payment information may be sent to a database and stored S63. It may be determined whether payment is being made using a voucher S64, and if so, payment voucher information may be sent to a voucher accepter subsystem for validation S66. The payment information may be validated by a database server S65 if payment is not by voucher.

It may be determined whether the payment has been validated S67 and if not, the postcard information may be purged from the server S68. Invalidated payment may be due to not enough information on the voucher to pay for the postcard, or the operator does not authorize the operator billing payment method for the user. The payment status (validated or non-validated) may be sent to a mobile operator or gateway S69 and then forwarded to the wireless communication device S70.

Although, example embodiments where the wireless communication device is a mobile phone with a digital camera, and where the print media is a postcard wereused to illustrate the present invention, as noted previously, the present invention is not limited by these embodiments and includes all other types of wireless communication devices (e.g., servers, workstations, desktop computers, Personal Digital Assistants (PDAs), portable computers, etc.) and media with print/images (e.g., greeting cards, stickers posters, signs, banners, mugs, plates, etc.) that are within the spirit and scope of the present invention.

Methods and apparatus for generation and sending of print media from a wireless communication device are advantageous for a number of reasons. Initially, it is a fast way to generate and deliver a print media since the print media may be generated anywhere in the world, but printed in a local printer server and mailed locally. Further, it is inexpensive, since a print media need not be mailed from one location and sent halfway across the world to another location. Further, it is fun and unique since a user may create their own picture of image for the print media on their mobile phone, or wireless communication device. Further, since not everyone has access to the Internet and is wired, a user may target individuals that don't have IP access.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A method for generating print media from a wireless communication device device comprising:
acquiring a picture for a media;
generating a text message for the media;
inputting a mailing address for the media;
creating media information from the picture, text message, and mailing address;
sending the media information to a server, the server storing the media information;
retrieving the media information from the server by a second server;
creating the media; and
mailing the created media to the mailing address.

2. The method according to claim 1, wherein the media comprises a postcard.

3. The method according to claim 1, wherein the media comprises one of a poster, stickers, a greeting card, a banner, a sign, a mug, or a plate.

4. The method according to claim 1, further comprising retrieving the media information from the server by a second server located in the country of the mailing address, the media being created at the second server location.

5. The method according to claim 1, the acquiring comprising taking the picture using a camera in the wireless communication device.

6. The method according to claim 1, the inputting comprising retrieving the mailing address from a list of stored addresses in the wireless communication device.

7. The method according to claim 1, further comprising generating a cost for the media based on the mailing address.

8. The method according to claim 7, further comprising determining a payment method for payment of the cost.

9. The method according to claim 7, further comprising sending payment information to a database, the database storing the payment information.

10. The method according to claim 9, further comprising validating and approving the cost information.

11. The method according to claim 9, further comprising rejecting the media information based on the cost information.

12. The method according to claim 7, further comprising paying for the media by submitting a voucher.

13. The method according to claim 7, further comprising paying for the media by getting approval to be billed.

14. The method according to claim 13, further comprising getting the approval from a mobile operator.

15. The method according to claim 1, further comprising sending the media information to the server via the Internet.

16. The method according to claim 1, further comprising sending the media information to the server via a mobile operator operatively connected to the Internet.

17. The method according to claim 1, further comprising retrieving the media information by accessing the server by the second server via the Internet.

18. The method according to claim 1, further comprising reviewing the created media for improper content and not mailing the media if it contains improper content.

19. The method according to claim 18, further comprising purging the media information from the server if the media contains improper content.

20. The method according to claim 1, further comprising purging the media from the server after the printing.

21. The method according to claim 1, further comprising notifying the wireless communication device that the media has been created and mailed.

22. The method according to claim 1., wherein the wireless communication device comprises a mobile phone.

23. The method according to claim 1, further comprising accessing a web server by the wireless communication device before the acquiring, the acquiring a picture, the generating a text message, the inputting a mailing address, the creating media information, and the sending the media information occurring from a web page at the web server.

24. The method according to claim 23, further comprising modifying the picture at the web page before the creating media information;

25. A system for generating media from a wireless communication device comprising:
a wireless communication device, the wireless communication device operatively connected to a network, the wireless communication device generating media information comprising a picture, a text message, and a mailing address;
a server, the server operatively connected to the network, the server receiving the media information from the wireless communication device and storing the media information; and
a second server, the second server operatively connected to the network, the second server retrieving the media information from the server, creating a media from the media information on a device attached to the second server allowing mailing of the media to the mailing address.

26. The system according to claim 25, wherein the media comprises one of a poster, stickers, a postcard, a greeting card, a banner, a sign, a mug, or a plate.

27. The system according to claim 25, the second server being located in the country of the mailing address.

28. The system according to claim 25, wherein the network comprises the Internet.

29. The system according to claim 25, further comprising a mobile operator operatively connected to the network, the mobile device sending the media information to the server via the mobile operator.

30. The system according to claim 29, wherein the mobile wireless communication device comprises a mobile phone.

31. A mobile device including a camera with instructions stored therein, the instructions when executed allowing the mobile device to perform:
taking a picture for a media using the camera of the mobile device;
receiving a text message for the media;
receiving a mailing address for the media;
creating media information from the picture, text message, and mailing address; and
sending the media information to a server.

32. The mobile device according to claim 31, wherein the media comprises one of a poster, stickers, a postcard, a greeting card, a banner, a sign, a mug, or a plate.

33. A method for generating media from a wireless communication device comprising:
taking a picture for a media;
generating a text message for the media;
inputting a mailing address for the media;
creating media information from the picture, text message, and mailing address;
sending the media information to a network printer, the network printer printing the media; and
mailing the printed media to the mailing address.

34. The method according to claim 33, wherein the media comprises one of a poster, stickers, a postcard, a greeting card, a banner, or a sign.

35. The method according to claim 33, the network printer being located in the country of the mailing address.

36. The method according to claim 33, further comprising sending the media information to the network printer via the Internet.

37. The method according to claim 33, further comprising transmitting a request to a server on a network comprising a plurality of network printers, the request sent to locate available network printers in the network.

38. The method according to claim 37, further comprising transmitting a message to the wireless communication device by the server identifying network printers available to the wireless communication device.

39. The method according to claim 33, wherein the network printer is located locally in relation to the wireless communication device.

40. A system for generating media from a wireless communication device comprising:
a wireless communication device, the wireless communication device operatively connected to a network, the wireless communication device generating media information comprising a picture, a text message, and a mailing address; and
a network second server, the network printer operatively connected to the network, the network printer creating a media from the media information allowing the mailing of the media to the mailing address.

41. The system according to claim 40, wherein the media comprises a postcard.

42. The system according to claim 40, wherein the media comprises one of a poster, stickers, a greeting card, a banner, or a sign.

43. The system according to claim 40, wherein the network printer is located in the country of the mailing address.

44. The system according to claim 40, wherein the network is the Internet.
